(19) United States
(12) Patent Application Publication
(10) Pub. No.: US 2003/0088321 A1
(43) Pub. Date: May 8, 2003

(54) Method for compensating for variations in modeled parameters of machines

(76) Inventors: Todd D. Creger, Geneva, IL (US); Javad Hosseini, Edelstein, IL (US); Jaganathan Sarangapani, Rolla, MI (US)

Correspondence Address: CATERPILLAR INC., 100 N.E. ADAMS STREET, PATENT DEPT., PEORIA, IL, 616296490

(21) Appl. No.: 10/006,959

(22) Filed: Nov. 5, 2001

(51) Int. Cl. G05B 13/02

(52) U.S. Cl. 700/30

(57) ABSTRACT

A method for compensating for variations in parameters of a plurality of machines having similar characteristics and performing similar operations. The method includes establishing a model development machine, obtaining data relevant to the modeled parameters, characteristics, and operations of each of at least one test machine, comparing the data from each test machine to corresponding data of the model development machine, and updating at least one of an estimator and a model of each test machine in response to variations in the compared data.

### TECHNICAL FIELD

This invention relates generally to a method for compensating for variations in modeled parameters of a plurality of machines and, more particularly, to a method for compensating for variations in modeled parameters of machines having similar characteristics and performing similar operations.

### BACKGROUND

It is often desired in the operations of machines of all types to maximize the efficiency of the machines while minimizing the costs of operations. This is particularly true with machines which perform the same types of work over a long period of time; that is, the work task is repetitive.

The development and use of neural networks and machine task modeling offers the distinct advantage of allowing a machine to “learn” how to improve operations over a period of time. This learning process increases efficiency and productivity by improving operations that are repetitive. More particularly, the machine adapts over time by modifying operations based on proven improvements in the work method being used.

A disadvantage of using neural networks to “learn” improved and more efficient operations is that the process inherently takes a long period of time. Thus, the improvements are gradually implemented as the machine continues to work in a relatively inefficient manner.

There are situations, however, in which several machines are being used to perform essentially similar functions. In such a case, it would be desired for machines to take advantage of the “learning” process already obtained by other machines that have been in operations longer. More specifically, it would be desired for newer machines to take advantage of the “learned” processes of older machines, while compensating for minor differences which exist from machine to machine, and from work site to work site.

The present invention is directed to overcoming one or more of the problems as set forth above.

### SUMMARY OF THE INVENTION

In one aspect of the present invention a method for compensating for variations in parameters of a plurality of machines having similar characteristics and performing similar operations is disclosed. The method includes the steps of establishing a model development machine, obtaining data relevant to the modeled parameters, characteristics, and operations of each of at least one test machine, comparing the data from each test machine to corresponding data of the model development machine, and updating at least one of an estimator and a model of each test machine in response to variations in the compared data.

In another aspect of the present invention a method for compensating for variations in parameters of a test machine compared to a model development machine is disclosed. The method includes the steps of delivering a neural network model from the model development machine to the test machine, determining a parameter on the test machine, estimating the parameter on the test machine with the delivered neural network, comparing the computed parameter with the estimated parameter, and updating at least one of an estimator and the neural network model on the test machine in response to variations in the compared data.

In yet another aspect of the present invention a method for compensating for variations in parameters of a plurality of machines having similar characteristics and performing similar operations is disclosed. The method includes the steps of collecting data from each of the plurality of machines relevant to the modeled parameters, characteristics, and operations of each respective machine, determining a level of variability of the characteristics of each machine, determining a level of variability of the operations of each machine relevant to a respective work site, determining an aging factor of each machine, and updating at least one of an estimator and a model of each machine in response to the level of variability of the characteristics of each machine, the level of variability of the operations of each machine relevant to each work site, and the aging factor.

### BRIEF DESCRIPTION OF THE DRAWINGS

FIG. 1 is a diagrammatic illustration of a plurality of machines at a plurality of work sites;

FIG. 2 is a diagrammatic illustration of a comparison of a machine parameter for a plurality of machines;

FIG. 3 is a flow diagram illustrating one aspect of a preferred method of the present invention;

FIG. 4 is a flow diagram illustrating another aspect of a preferred method of the present invention;

FIG. 5 is a flow diagram illustrating yet another aspect of a preferred method of the present invention;

FIG. 6 is a block diagram illustrating a preferred embodiment of the present invention;

FIG. 7 is a diagrammatic illustration of an application of the present invention; and

FIG. 8 is a diagrammatic illustration of another embodiment of an application of the present invention.

### DETAILED DESCRIPTION

With reference to the drawings and the appended claims, a method is disclosed for compensating for variations in modeled parameters of a plurality of machines 102 having similar characteristics and performing similar operations.

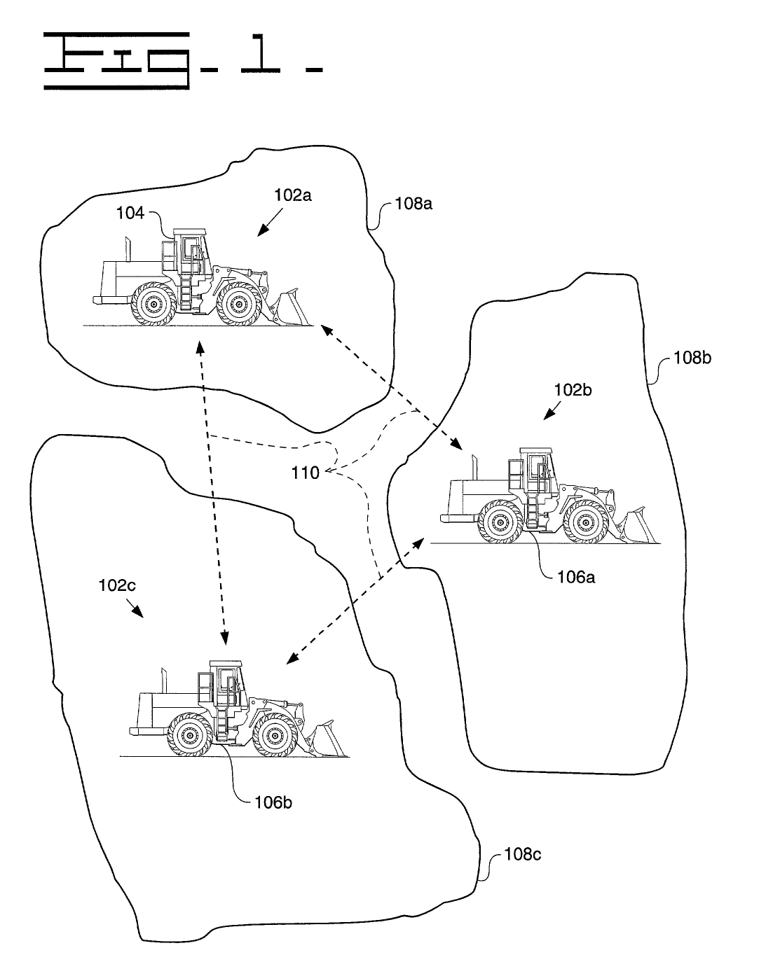

Referring to FIG. 1, a plurality of machines 102 are shown at a corresponding plurality of work sites 108. In particular, a first machine 102a is located at a first work site 108a, a second machine 102b is located at a second work site 108b, and a third machine 102c is located at a third work site 108c. Although FIG. 1 indicates three machines 102a,b,c, it is understood that any number of machines 102 may be used and applied with the present invention.

The machines 102 shown in FIG. 1 are depicted as earthworking machines, more particularly wheel loaders. However, the illustration of earthworking machines is only used as an example to describe the present invention. Any of a wide variety of types of machines, mobile or fixed, may benefit from use of the present invention, as long as the machines are similar to each other and are used to perform similar work functions.

In FIG. 1, the first machine 102a is depicted as a model development machine 104, and the second and third machines 102b,c are depicted as test machines 106a,b, respectively. The use of this nomenclature is made apparent from the detailed description contained below.

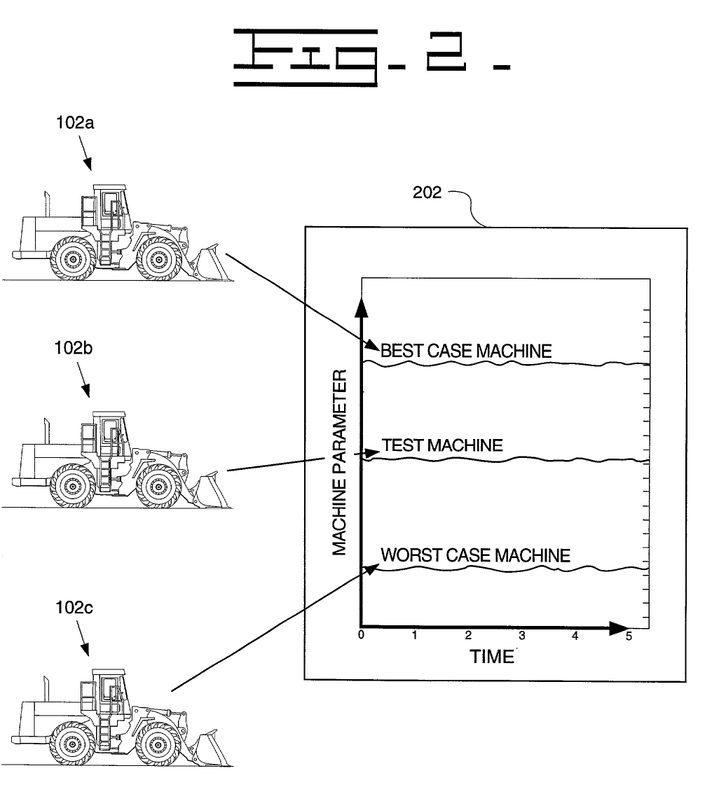

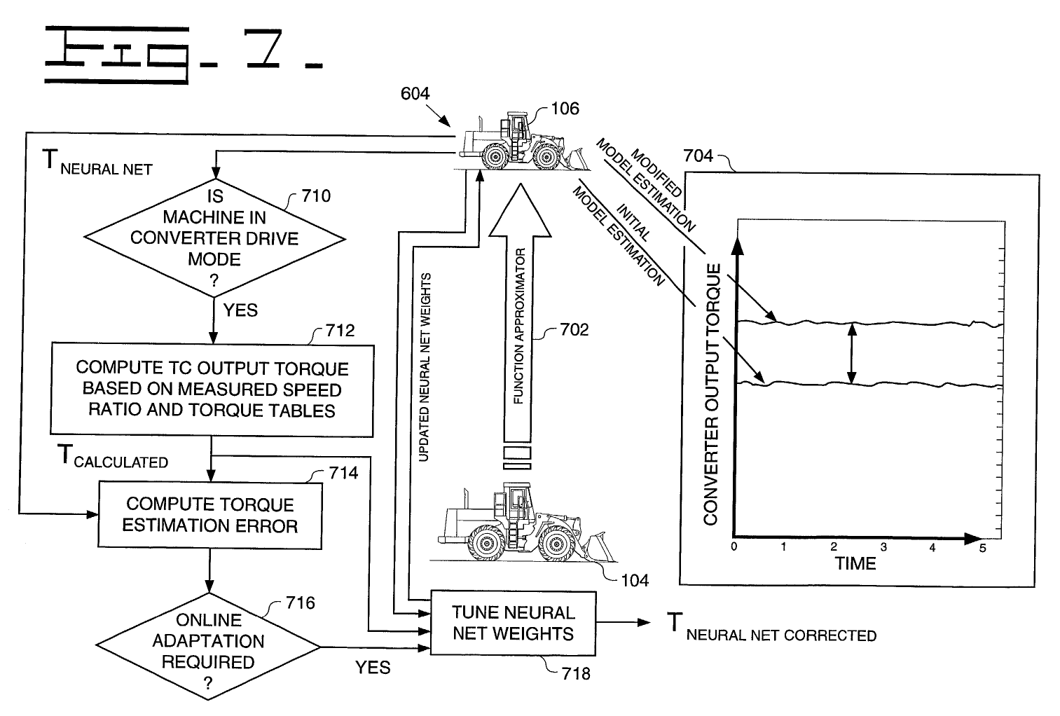

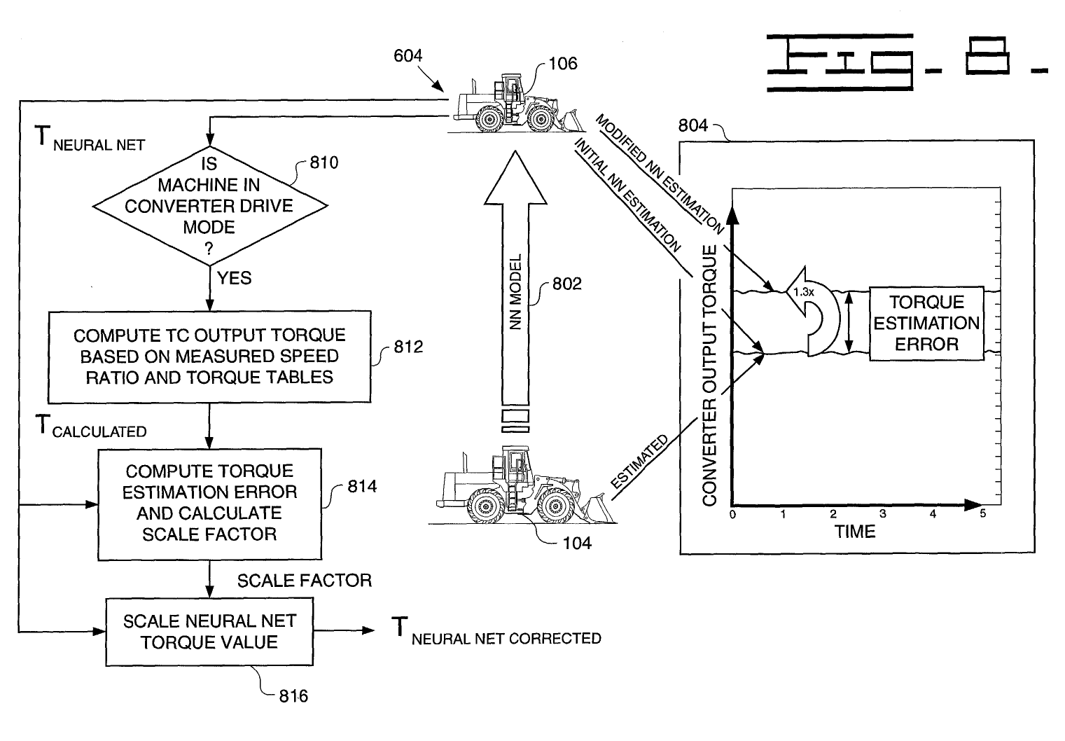

Referring to FIG. 2, the first, second, and third machines 102a,b,c are shown with reference to a graph 202 of machine parameters. The machine parameter may be any of a wide variety of types in which it is desired to monitor the operation of the machines 102. For example, as FIGS. 7 and 8 illustrate, the machine parameter may be the torque at the output of a torque converter (not shown). Other exemplary machine parameters may include fuel consumption, engine operations (such as temperature, pressure, and the like), implement movement or speed, hydraulic pressure or temperature, and others.

The machine parameter over a period of time is recorded on the graph 202 for each machine 102, i.e., a separate plot for each machine 102 is shown on the graph 202. In the preferred embodiment, each machine 102 has a resultant plot of the machine parameter that is contained within upper and lower threshold boundaries. For example, each machine parameter plot is contained within an upper boundary shown as a best case machine plot and a lower boundary shown as a worst case machine plot. If a machine parameter plot is not contained within the desired boundary, the model which estimates the machine parameter must be tuned to obtain a more accurate estimate.

As an example of a machine parameter being outside the acceptable boundary, assume that the test machine 106a in FIG. 1 is reassigned from the second work site 108b to the first work site 108a. The two work sites 108a,b may have different characteristics, e.g., the materials at each work site 108a,b may differ. As a result, the test machine 106a may be using a model, e.g., a neural network, to estimate the machine parameter which is tuned for the second work site 108b. Thus, a plot of the machine parameter of the test machine 106a may now be outside acceptable values. Therefore, the model must be tuned to account for the changed characteristics of the new work site 108a.

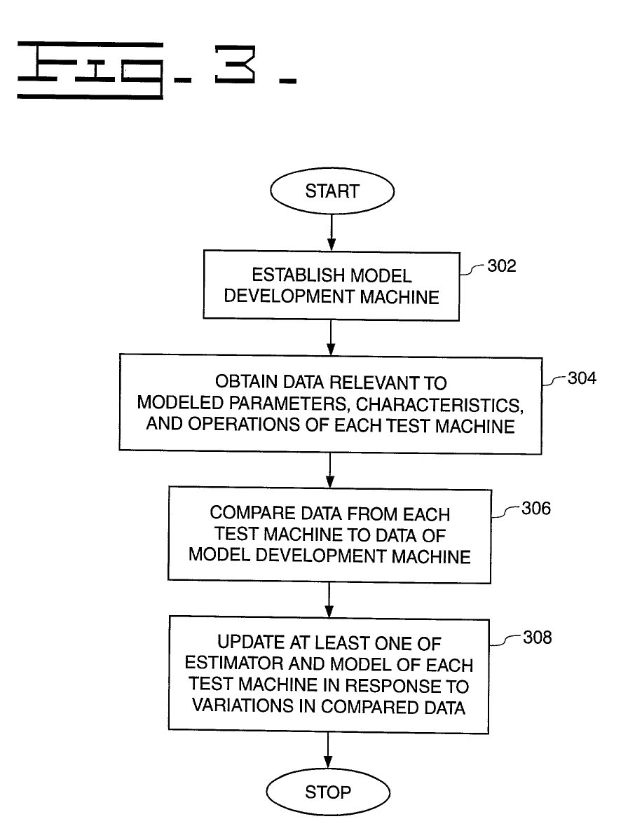

Referring to FIG. 3, a flow diagram illustrating a first embodiment of the present invention is shown.

In a first control block 302, a model development machine 104 is established. Preferably, the model development machine 104 will be a machine 102 which has been in operation at a work site 108 for a relatively long period of time. Thus, the model used to estimate a machine parameter will have had ample opportunity to tune itself for an accurate estimate. Alternatively, the model development machine 104 may be a machine 102 which has a neural network that has been tuned under controlled conditions, e.g., in a lab environment.

In a second control block 304, each machine 102 obtains data from the other machines 102 relevant to modeled parameters, characteristics, and operations of each test machine 106. In the preferred embodiment, modeled parameters are the estimates obtained from neural network models from each machine 102, characteristics include conditions at each work site 108, and operations of each test machine 106 include operating parameters for each machine 102 as work is performed. In addition, data relevant to aging of each machine 102 is included. As a machine ages, wear and tear on the machine 102 results in perceptible changes in operating characteristics, and thus should be accounted for.

In a third control block 306, the data obtained from each test machine 106 is compared to data from the model development machine 104.

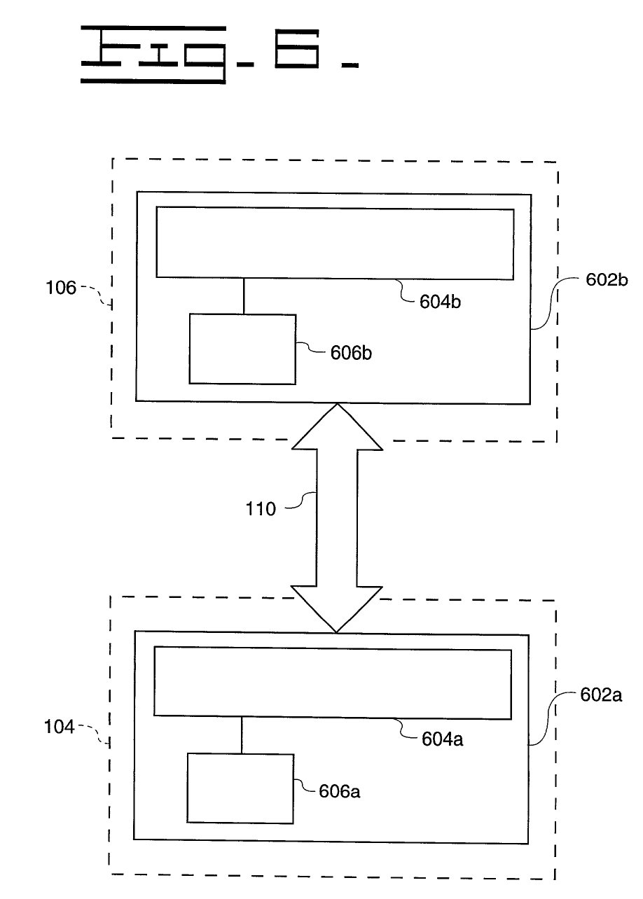

In a fourth control block 308, at least one of an estimator and a model of each test machine 106 is updated in response to variations in compared data. For example, as FIG. 6 illustrates, the model development machine 104 preferably includes a first processor 602a, and the test machine 106 preferably includes a second processor 602b. The first and second processors 602a,b preferably include respective first and second neural networks 604a,b. The neural networks 604 are used to estimate a machine parameter. If the machine parameter of the test machine 106 is not within acceptable values, the neural network 604b of the test machine 106 may be updated. Alternatively, an estimator 606b at the test machine 106 may be updated to bring the machine parameter within acceptable values. The estimator 606b is essentially a multiplier chosen to adjust the estimated output value of the neural network 604b. It is noted that the model development machine 104 is shown in FIG. 6 with an estimator 606a also. In some circumstances, the model development machine 104 may function as a test machine 606, and thus the estimator 606a may be used in the same manner described above.

Furthermore, as is shown in FIG. 6, a communications link 110 is used to provide communications, preferably wireless, between the model development machine 104 and the test machine 106. The communications link 110 may be of any type well known in the art, and is therefore not described further.

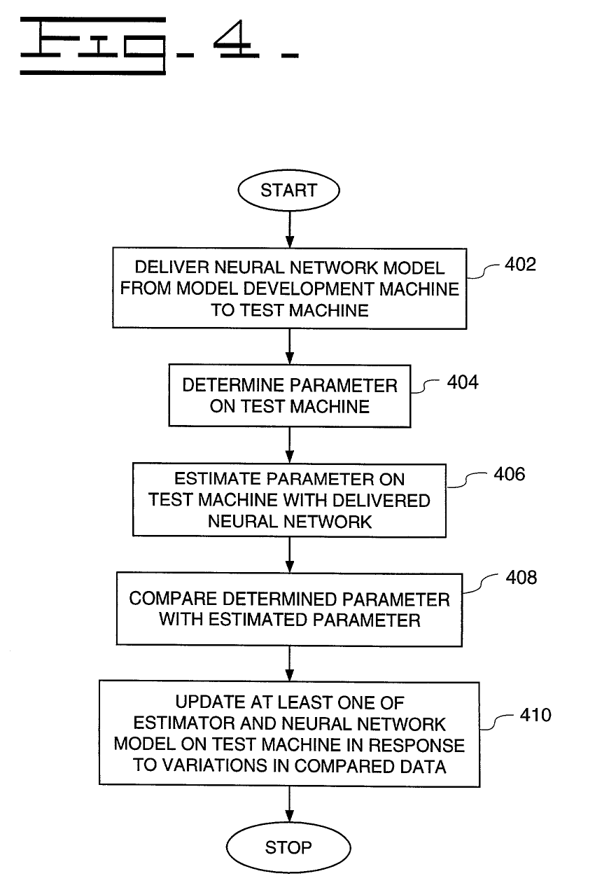

Referring to FIG. 4, a flow diagram illustrating an alternative embodiment of the present invention is shown. Reference is also made to FIGS. 7 and 8 to further describe the present invention.

In a first control block 402, a neural network model 802 is delivered from the model development machine 104 to each test machine 106. Preferably, the neural network model 802 of the model development machine 104 offers the advantage of having “learned” over a long period of time, under controlled conditions. Thus, the neural network model 802 has already experienced the long learning period required of neural networks. This eliminates the time period previously needed for the test machines 106 to teach their own neural networks.

In a second control block 404, a desired machine parameter is determined on each test machine 106, preferably by standard means such as measurement, computation, or calculation.

In a third control block 406, the desired machine parameter is estimated on each test machine 106 by the delivered neural network model 802. Control proceeds to a fourth control block 408, in which the determined parameter is compared with the estimated parameter.

In a fifth control block 410, at least one of the estimator 606 and the neural network 604 is updated on each test machine 106 in response to variations in the compared data. In the preferred embodiment, updating the neural network 604 includes tuning at least one neural network weight in the neural network. Neural network weights are well known in neural network theory and applications, and will not be described further.

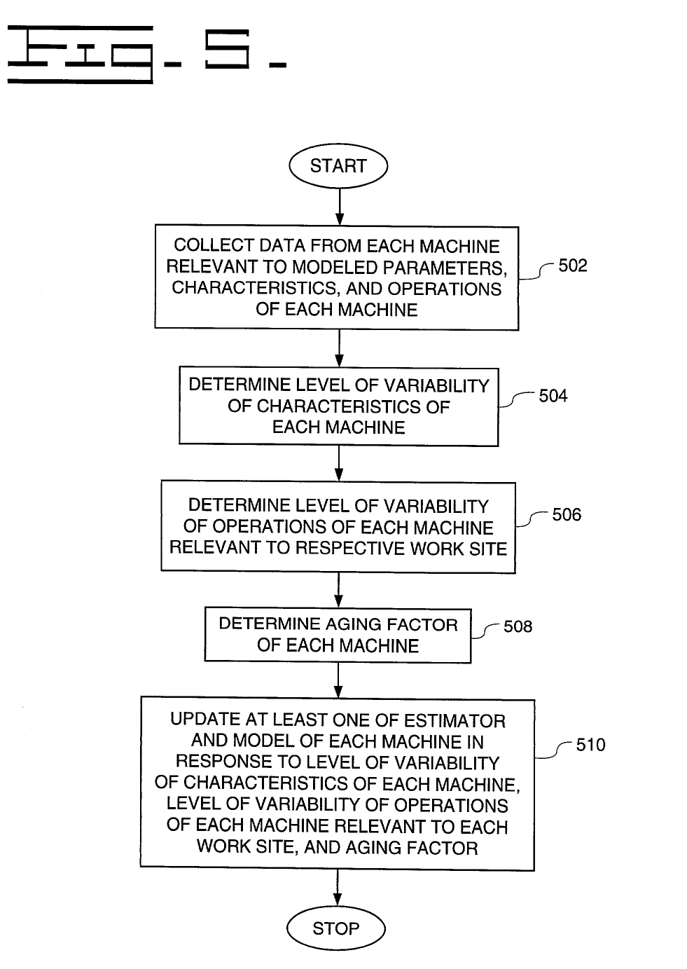

Referring to FIG. 5, a flow diagram illustrating another embodiment of the present invention is shown.

In a first control block 502, data is collected from each machine 102 relevant to modeled parameters, characteristics, and operations of each machine 102 in the same manner as described above.

In a second control block 504, a level of variability of characteristics of each machine 102 is determined. The level of variability of characteristics of each machine 102 includes, but is not limited to, variations in operating parameters from machine to machine, such as operating temperatures, pressures, stresses, loads, speeds, and the like.

In a third control block 506, a level of variability of operations of each machine 102 relevant to respective work sites 108 is determined. The level of variability may be a function of such factors as conditions at each work site 108, the type of material being worked on at each work site 108, environmental conditions at each work site 108, and the like. For example, in an earthworking application having wheel loaders as machines 102, a first work site 108a may include one type of material being dug and loaded, and a second work site 108b may include another type of material being dug and loaded, e.g., copper ore at the first work site 108a and coal ore at the second work site 108b.

In a fourth control block 508, an aging factor for each machine 102 is determined. For example, at the start of each shift or day of operation, the number of hours of work of each machine 102 may be logged. The number of hours of operation may then be converted into an aging factor to account for normal wear and tear of the machine 102.

It is noted that other levels of variability may be determined as well without deviating from the spirit and scope of the present invention. For example, operating characteristics of human operators may be monitored and taken into account, since operators may invoke varying degrees of wear on a machine 102.

In a fifth control block 510, at least one of an estimator 606 and a neural network 604 of each machine 102 is updated in response to the level of variability of characteristics of each machine 102, the level of variability of operations of each machine 102 relevant to each respective work site 108, and the aging factor of each machine 102.

### INDUSTRIAL APPLICABILITY

As an example of application of the present invention for use with machines 102 at work sites 108, reference is made to FIGS. 7 and 8. As both Figs. indicate, a model development machine 104 and a test machine 106 coordinate operations to determine variability in estimated parameters, and update the results accordingly. The machines 102 are depicted as earthworking machines, specifically wheel loaders, for exemplary purposes only. The machine parameter of interest is the torque at the output of a torque converter (not shown). FIG. 7 and FIG. 8 differ slightly in the method used, and each is considered more closely.

In FIG. 7, a function approximator 702 is delivered from the model development machine 104 to the test machine 106. A function approximator is a model which approximates a function. For example, a regression model may be used as a function approximator. Alternatively, a neural network may be used as a function approximator. Referring to the flow diagram portion of FIG. 7, the test machine 106 determines whether it is in converter drive mode in a first decision block 710. If the test machine 106 is in converter drive mode, the output torque of the torque converter is computed in a first control block 712, preferably using measured speed ratios and torque tables. In a second control block 714, the computed torque is compared with an estimated torque from a neural network 604 located on the test machine 106, and a torque estimation error is determined. If, in a second decision block 716, it is determined that online adaptation of the test machine neural network 604 is required, then at least one neural network weight on board the test machine 106 is tuned to correct the neural network output. The compensation is illustrated on a first graph 704 of machine output torques, in which the converter output torque plot is adjusted from an initial model estimation value to a modified model estimation value. It is noted that the step in the first control block 712 is not always available for computing the output torque due to operating conditions of the test machine 106. Therefore, the estimated torque output provided by the neural network 604 provides a method to determine torque at all times during operation of the test machine 106.

In FIG. 8, a neural network model 802 is delivered from the model development machine 104 to the test machine 106. Referring to the flow diagram portion of FIG. 8, in a first decision block 810, it is determined whether the test machine 106 is in converter drive mode. If the test machine 106 is in converter drive mode then, in a first control block 812, the torque converter output torque is computed, preferably by the method described above. In a second control block 814, a torque estimation error is determined and a resultant scale factor is calculated. For example, as shown in a second graph 804 of machine output torques, the scale factor is determined to be 1.3. In a third control block 816, the estimated value of output torque from the neural network 604 is scaled by the scale factor to obtain a corrected, i.e., compensated, value of output torque from the neural network 604.

Other aspects, objects, and features of the present invention can be obtained from a study of the drawings, the disclosure, and the appended claims.

What is claimed is:

1. A method for compensating for variations in modeled parameters of a plurality of machines having similar characteristics and performing similar operations, including the steps of:
establishing a model development machine;
obtaining data relevant to the modeled parameters, characteristics, and operations of each of at least one test machine;
comparing the data from each test machine to corresponding data of the model development machine; and
updating at least one of an estimator and a model of each test machine in response to variations in the compared data.

2. A method, as set forth in claim 1, wherein each of the model development machine and the at least one test machine includes a neural network for modeling a parameter of each respective machine, and wherein updating at least one of an estimator and a model includes the step of updating an estimator for each neural network in response to variations in the compared data.

3. A method, as set forth in claim 1, wherein each of the model development machine and the at least one test machine includes a neural network for modeling a parameter of each respective machine, and wherein updating at least one of an estimator and a model includes the step of updating each neural network in response to variations in the compared data.

4. A method, as set forth in claim 1, wherein obtaining data includes the step of obtaining data from each test machine relevant to operating characteristics of each respective test machine.

5. A method, as set forth in claim 1, wherein obtaining data includes the step of obtaining data from a work site in which a respective test machine is located, the data including data relevant to characteristics of the work site and operations of the test machine at the work site.

6. A method, as set forth in claim 1, wherein obtaining data includes the step of obtaining data relevant to aging of each test machine.

7. A method for compensating for variations in modeled parameters of a test machine compared to a model development machine, including the steps of:
delivering a neural network model from the model development machine to the test machine;
determining a parameter on the test machine;
estimating the parameter on the test machine with the delivered neural network;
comparing the computed parameter with the estimated parameter; and
updating at least one of an estimator and the neural network model on the test machine in response to variations in the compared data.

8. A method, as set forth in claim 7, wherein determining a parameter includes the step of calculating the parameter.

9. A method, as set forth in claim 7, wherein updating a neural network model includes the step of tuning at least one weight in the neural network model.

10. A method for compensating for variations in modeled parameters of a plurality of machines having similar characteristics and performing similar operations, including the steps of:
collecting data from each of the plurality of machines relevant to the modeled parameters, characteristics, and operations of each respective machine;
determining a level of variability of the characteristics of each machine;
determining a level of variability of the operations of each machine relevant to a respective work site;
determining an aging factor of each machine; and
updating at least one of an estimator and a model of each machine in response to the level of variability of the characteristics of each machine, the level of variability of the operations of each machine relevant to each work site, and the aging factor.

11. A method, as set forth in claim 10, wherein determining a level of variability of the operations of each machine relevant to a respective work site includes the step of determining a level of variability as a function of differences in characteristics between each work site.

12. A method, as set forth in claim 10, wherein determining an aging factor of each machine includes the step of determining a level of variability of operations of each machine as a function of aging of each respective machine.
